(19) United States
(12) Patent Application Publication
(10) Pub. No.: US 2018/0373053 A1
(43) Pub. Date: Dec. 27, 2018

(54) STEREOSCOPIC DISPLAY

(71) Applicant: Delta Electronics, Inc., Taoyuan City (TW)

(72) Inventor: June-Jei HUANG, Taoyuan City (TW)

(21) Appl. No.: 15/867,105

(22) Filed: Jan. 10, 2018

(30) Foreign Application Priority Data
Jun. 22, 2017 (CN) 201710480379.4

(51) Int. Cl. G02B 27/22; F21V 8/00

(52) U.S. Cl. CPC G02B 27/2214; G02B 6/0038; G02F 1/133514; G02B 6/003; G02B 6/005; G02B 6/0061

(57) ABSTRACT

A portrait and landscape convertible stereoscopic display includes a first lenticular structure, a display panel, and a second lenticular structure. The first lenticular structure includes first cylinder lenses extending along a first direction and parallel to each other. The display panel is disposed on the first lenticular structure. The second lenticular structure is disposed on the display panel, and includes second cylinder lenses extending along an inclined direction and parallel to each other.

### CROSS-REFERENCE TO RELATED APPLICATIONS

This Application claims priority of China Patent Application No. 201710480379.4 filed on Jun. 22, 2017, the entirety of which is incorporated by reference herein.

### BACKGROUND OF THE INVENTION

### Field of the Invention

The present disclosure relates to a display, and in particular to a stereoscopic display.

### Description of the Related Art

Conventional stereoscopic displays provide stereoscopic images to users. The stereoscopic display provides a left-eye image to the user's left eye, and a right-eye image to the user's right eye. When the left-eye image is seen with the left eye, and the right-eye image is seen with the right eye, the user perceives a stereoscopic image.

The user has a more immersive feeling with stereoscopic images compared to 2D images. Therefore, stereoscopic displays are used in a variety of electronic devices, such as televisions, tablet computers, laptop computers, and smart phones.

When handheld electronic devices such as tablet computers and smartphones require a stereoscopic display, a naked stereoscopic display is usually utilized in order to make it convenient for users to watch it at any time. Users do not need to wear three-dimensional glasses, and can perceive the stereoscopic image directly from the stereoscopic display using only the naked eye.

However, when the user looks at a stereoscopic display on a handheld electronic device, it may be difficult for the device to present stereoscopic images, or to present stereoscopic images of great quality, on the stereoscopic display since the user may shift among different angles of view, or because the stereoscopic display is disposed in different orientations. This can make use of the device inconvenient.

### BRIEF SUMMARY OF THE INVENTION

The present disclosure provides a stereoscopic display providing stereoscopic images, which can be viewed at different angles of view. The quality of the stereoscopic image is great even when the stereoscopic display is operated in portrait view or landscape view.

The present disclosure provides a stereoscopic display including a first lenticular structure, a display panel, and a second lenticular structure. The first lenticular structure includes first cylinder lenses extending along a first direction and parallel to each other. The display panel is disposed on the first lenticular structure. The second lenticular structure is disposed on the display panel, and includes second cylinder lenses extending along an inclined direction and parallel to each other. There is an acute angle between the inclined direction and the first direction.

In some embodiments, the display panel includes pixels extending along a second direction and parallel to each other. The second direction is perpendicular to the first direction. Light beams passing through the first cylinder lenses are emitted from illumination areas on a light-emitting surface of the display panel. The illumination areas extends along the first direction and parallel to each other. The width of the illumination areas is shorter than the length of the pixels. The width and the length are measured in the second direction.

In some embodiments, the illumination areas pass through center areas of the pixels arranged in the first direction. The length of the pixels is about 1.1 times to 20 times the width of the illumination areas. When the pixels emit light beams, the illumination in the illumination areas of the pixels is greater than the illumination outside the illumination areas of the pixels. The pixels are arranged on the light-emitting surface of the display panel in an array.

In some embodiments, the pixels include green pixels, blue pixels, and red pixels. The green pixels, the blue pixels, and the red pixels are alternately arranged in the first direction. Some of the pixels with the same colors are arranged in the second direction.

In some embodiments, the first lenticular structure, the display panel, and the second lenticular structure are parallel to each other. The first cylinder lenses are located on a first plane, and the second cylinder lenses are located a second plane parallel to the first plane. The acute angle is in a range from about 30 degrees to 60 degrees.

In some embodiments, the stereoscopic display further includes a light-guide plate and a light source. The light-guide plate is disposed under the first lenticular structure, and the light source is disposed on a side of the light-guide plate.

In some embodiments, the light-guide plate further includes a light-guide layer and semi-cylindrical microlenses located at the bottom of the light-guide layer. The diameter of the semi-cylindrical microlenses increase gradually from the side of the light-guide layer adjacent to the light source to another side that is far from the light source.

In some embodiments, the light source further includes a condensing-lenticular structure and light-emitting elements disposed on the condensing-lenticular structure. The condensing-lenticular structure includes condensing-cylinder lenses parallel to each other and adjacent to the light-guide plate.

The disclosure provides a stereoscopic display including a display panel, a first lenticular structure, and a second lenticular structure. The first lenticular structure is disposed on the first lenticular structure. The first lenticular structure includes first cylinder lenses extending along a first direction and parallel to each other. The second lenticular structure is disposed on the display panel, and includes second cylinder lenses extending along an inclined direction and parallel to each other. An acute angle is between the first direction and the inclined direction.

In conclusion, the stereoscopic display of the disclosure utilizes the second lenticular structure to provide stereoscopic images in different orientations. Moreover, using the first lenticular structure, the stereoscopic display can provide stereoscopic images of great quality in different orientations or when the stereoscopic display is viewed at different angles of view.

### BRIEF DESCRIPTION OF THE DRAWINGS

The invention can be more fully understood by reading the subsequent detailed description and examples with references made to the accompanying drawings, wherein:

FIG. 1 is a cross-sectional view of the stereoscopic display in accordance with some embodiments of the disclosure.

FIG. 2 is an exploded view of the stereoscopic display in accordance with some embodiments of the disclosure.

FIG. 3A is a schematic top view of the stereoscopic display in accordance with some embodiments of the disclosure.

FIG. 3B is a schematic view of angles of view of the stereoscopic display in accordance with some embodiments of the disclosure.

FIG. 4 is a schematic view of angles of view of the stereoscopic display in accordance with some embodiments of the disclosure.

FIG. 5 is a schematic top view of the stereoscopic display in another orientation in accordance with some embodiments of the disclosure.

FIG. 6A is a schematic top view of the stereoscopic display in accordance with some embodiments of the disclosure.

FIG. 6B is a schematic view of angles of view of the stereoscopic display in accordance with some embodiments of the disclosure.

### DETAILED DESCRIPTION OF THE INVENTION

The following disclosure provides many different embodiments, or examples, for implementing different features of the present disclosure. Specific examples of components and arrangements are described below to simplify the present disclosure. For example, the formation of a first feature over or on a second feature in the description that follows may include embodiments in which the first and second features are formed in direct contact, and may also include embodiments in which additional features may be formed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed.

Spatially relative terms, such as upper and lower, may be used herein for ease of description to describe one element or feature's relationship to other elements or features as illustrated in the figures. The spatially relative terms are intended to encompass different orientations of the device in use or operation in addition to the orientation depicted in the figures. The shape, size, and thickness depicted in the drawings may not be drawn to scale or may be simplified for clarity of discussion; these drawings are merely intended for illustration.

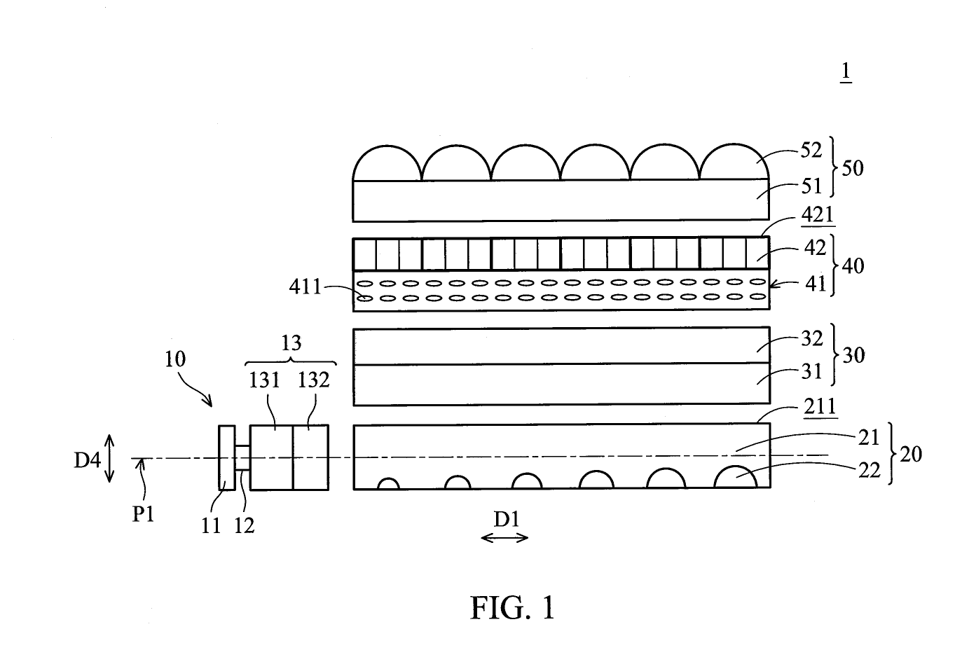

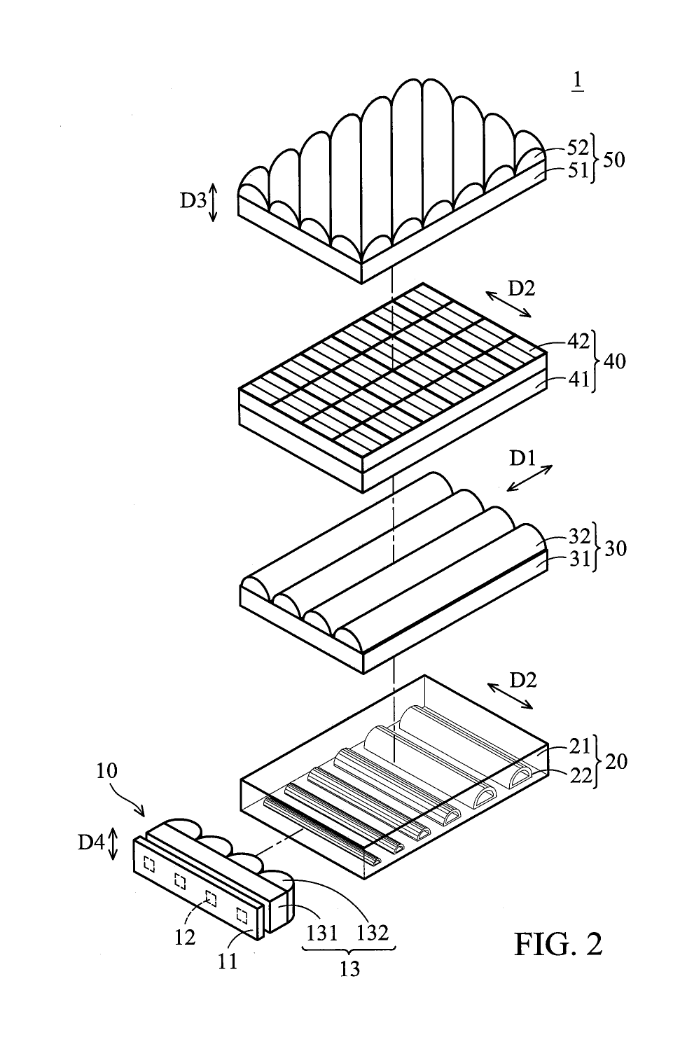

FIG. 1 is a cross-sectional view of the stereoscopic display 1 in accordance with some embodiments of the disclosure. FIG. 2 is an exploded view of the stereoscopic display 1 in accordance with some embodiments of the disclosure. The stereoscopic display 1 is configured to present a stereoscopic image to a user. The stereoscopic display 1 provides a left-eye image to the user's left eye, and provides a right-eye image to the user's right eye. The left-eye image is different from the right-eye image. When the user watches the left-eye image with the left eye, and the right-eye image with the right eye, a stereoscopic image is perceived by the user.

In this embodiment, the stereoscopic display 1 may be a naked-eye stereoscopic display. The user watches stereoscopic images without wearing stereoscopic glasses. The stereoscopic display 1 may be a spatial-multiplex stereoscopic display. The user can watch the stereoscopic images from different angles of view of the stereoscopic display 1. Furthermore, the stereoscopic display 1 may be an auto-stereoscopic display. The stereoscopic display 1 may be operated in portrait view or landscape view, and the stereoscopic display 1 presents stereoscopic images to the user in portrait view and landscape view.

In some embodiments, the stereoscopic display 1 is installed in an electronic device, such as a smart phone, a tablet computer, a laptop computer, a display, and a television.

The stereoscopic display 1 includes a light source 10, a light-guide plate 20, a first lenticular structure 30, a display panel 40, and a second lenticular structure 50. The light source 10 is configured to emit light beams to the light-guide plate 20. In this embodiment, the light source 10 includes a printed circuit board 11, light-emitting elements 12, and a condensing-lenticular structure 13.

The printed circuit board 11 may be an elongated structure extending along a second direction D2. The printed circuit board 11 may be parallel to a side surface of the light-guide plate 20, and adjacent to the light-guide plate 20. The light-emitting elements 12 are disposed on the printed circuit board 11. The light-emitting elements 12 may be light-emitting diodes, arranged on the printed circuit board 11 along the second direction D2. The light-emitting elements 12 are configured to emit light beams to the light-guide plate 20.

The condensing-lenticular structure 13 is disposed on the light-emitting elements 12. The light-emitting elements 12 are arranged on a condensing surface of the condensing-lenticular structure 13 in an array. The condensing-lenticular structure 13 is transparent. The condensing-lenticular structure 13 may be an elongated structure extending along the second direction D2. The condensing-lenticular structure 13 may be parallel to the printed circuit board 11, and adjacent to a side surface of the light-guide plate 20.

The condensing-lenticular structure 13 includes a condensing-base layer 131 and a condensing-cylinder lens 132. The condensing-base layer 131 may be an elongated structure, parallel to the printed circuit board 11. The condensing-cylinder lens 132 is disposed on the condensing-base layer 131. In this embodiment, the condensing-cylinder lens 132 is arranged on the same surface of the condensing-base layer 131. The condensing-cylinder lenses 132 may be parallel to each other, and adjacent to a side surface of the light-guide plate 20. The condensing-cylinder lens 132 may be a semi-cylindrical structure extending along a stacking direction D4 perpendicular to the second direction D2.

The light-guide plate 20, the first lenticular structure 30, the display panel 40, and the second lenticular structure 50 are parallel to each other, and stacked in the stacking direction D4 in sequence. The light-guide plate 20 may be a plate structure extending perpendicular to the stacking direction D4. The light-guide plate 20 is transparent. The light-guide plate 20 is adjacent to the light source 10, and is configured to transmit the light beams generated by the light source 10. Moreover, the light-guide plate 20 uniformly emits the light beams generated by the light source 10 via a light-emitting surface 211 of the light-guide plate 20.

The light-guide plate 20 includes a light-guide layer 21 and semi-cylindrical microlenses 22. The light-guide layer 21 extends along a reference plane P1, and adjacent to the light source 10. The reference plane P1 is perpendicular to the printed circuit board 11 and the condensing-lenticular structure 13. In this embodiment, the reference plane P1 is a flat plane. In some embodiments, the reference plane P1 is a curved plane.

The semi-cylindrical microlenses 22 are located at the bottom of the light-guide layer 21. After the light beams generated by the light source 10 enter into the light-guide layer 21, the light beams are transmitted in the light-guide layer 21. The light beams may be reflected or totally reflected in the light-guide layer 21. The light beams emitted on the semi-cylindrical microlenses 22 are reflected to the light-emitting surface 211 by the semi-cylindrical microlenses 22.

The diameter of the semi-cylindrical microlens 22 increases gradually from the side of the light-guide layer 21 adjacent to the light source 10 to another side far from the light source 10. The diameter is measured on a plane parallel to the reference plane P1. The diameter of the semi-cylindrical microlens 22 is substantially consistent in the second direction D2. Because of the structure of the semi-cylindrical microlenses 22, the light beams passing through the light-emitting surface 211 of the light-guide plate 20 are uniform.

The first lenticular structure 30 is disposed on the light-guide plate 20, and configured to focus the light beams, with different transmitting directions, emitted from the light-guide plate 20 on different positions of the display panel 40. The first lenticular structure 30 is transparent. The main surface of the first lenticular structure 30 is substantially equal to the main surface (light-emitting surface 211) of the light-guide plate 20.

The first lenticular structure 30 includes a first base layer 31 and first cylinder lenses 32. The first base layer 31 extends parallel to the reference plane P1. The first cylinder lens 32 is disposed on the first base layer 31. The first cylinder lens 32 may be semi-cylindrical structure, and extend along the first direction D1 and parallel to each other. In this embodiment, the first direction D1 is perpendicular to the second direction D2. The first direction D1 and the second direction D2 are parallel to the reference plane P1.

The display panel 40 is disposed on the first lenticular structure 30, and configured to display an image. In this embodiment, the display panel 40 is a liquid-crystal display panel.

In this embodiment, the display panel 40 includes a liquid-crystal layer 41 and the pixels 42. The liquid-crystal layer 41 extends parallel to the reference plane P1. The liquid-crystal layer 41 includes liquid-crystal molecules 411. The orientations of the liquid-crystal molecules 411 can be changed by applying an electric field to the liquid-crystal molecules 411. Moreover, the quantity of the light beams passing through the liquid-crystal layer 41 can be changed by adjusting the orientations of the liquid-crystal molecules 411.

The pixels 42 are disposed on the liquid-crystal layer 41. The pixels 42 are arranged on a light-emitting surface 421 of the display panel 40 in an array. In this embodiment, the pixels 42 are rectangles. The pixels 42 may extend along the second direction D2 and parallel to each other. In this embodiment, the pixels 42 are color filters.

After the light beams pass through red color filters, the light beams are changed to red light. After the light beams pass through green color filters, the light beams are changed to green light. After the light beams pass through blue color filters, the light beams are changed to green light.

The condensing surface of the second lenticular structure 50 is disposed on the display panel 40, and configured to convert the light beams emitted from different positions of the display panel 40 to different angels of view. The second lenticular structure 50 is transparent. The area of the main surface of the second lenticular structure 50 is substantially equal to the area of the main surface of the first lenticular structure 30.

The second lenticular structure 50 includes a second base layer 51 and second cylinder lenses 52. The second base layer 51 extends parallel to the reference plane P1. The second cylinder lenses 52 are disposed on the second base layer 51. The second cylinder lenses 52 may be semi-cylindrical structures extending along the inclined direction D3 and parallel to each other. In this embodiment, an acute angle is between the first direction D1 and the inclined direction D3. The acute angle is in a range from about 30 degrees to 60 degrees. As shown in FIG. 1, the acute angle is about 45 degrees.

In this embodiment, the first cylinder lenses 32 are located on a plane that is parallel to the reference plane P1, and the second cylinder lenses 52 are located on a plane that is parallel to the reference plane P1. Moreover, in this embodiment, the first direction D1, the second direction D2 and the inclined direction D3 are parallel to the reference plane P1.

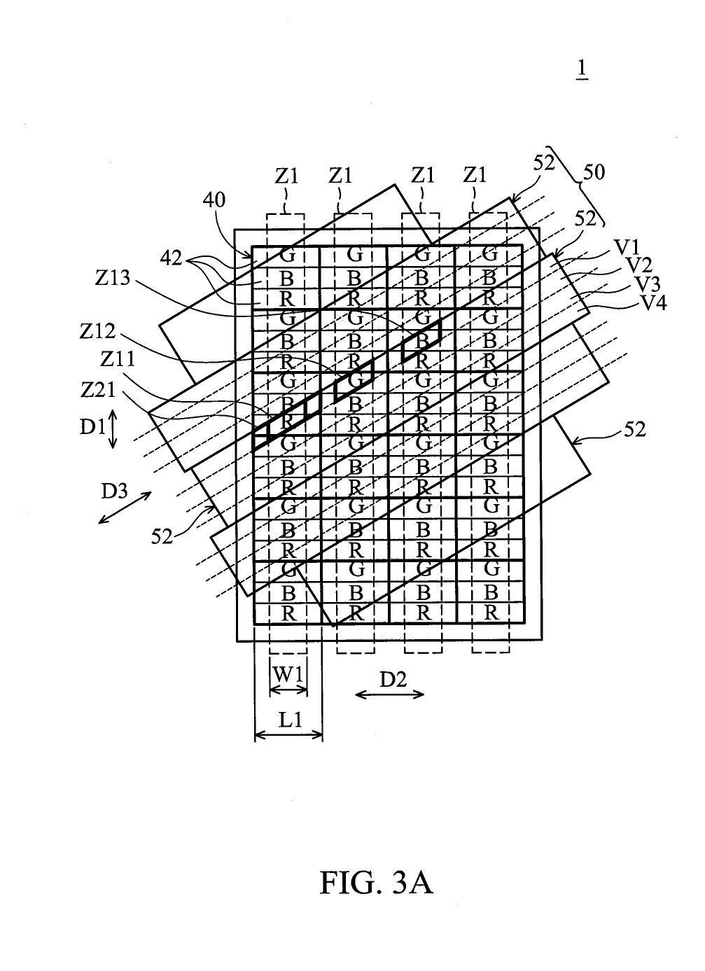

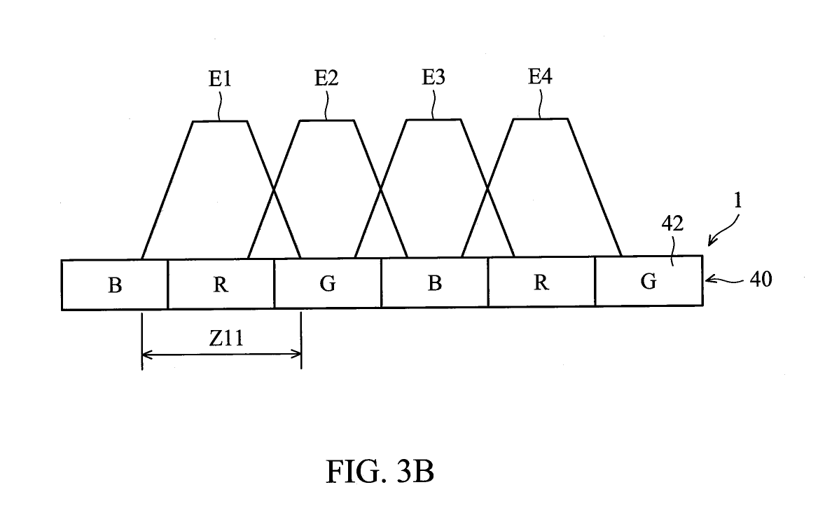

FIG. 3A is a schematic top view of the stereoscopic display 1 in accordance with some embodiments of the disclosure. FIG. 3B is a schematic view of angles of view of the stereoscopic display 1 in accordance with some embodiments of the disclosure. The light beams generated from the light source 10 are emitted to the first lenticular structure 30 via the light-guide plate 20. The light beams emitted from the light-guide plate 20 are condensed by the first cylinder lenses 32 of the first lenticular structure 30, and the light beams are emitted to the display panel 40. After the light beams pass through the pixels 42, the light beams are emitted from the illumination areas Z1 on the light-emitting surface 421 of the display panel 40.

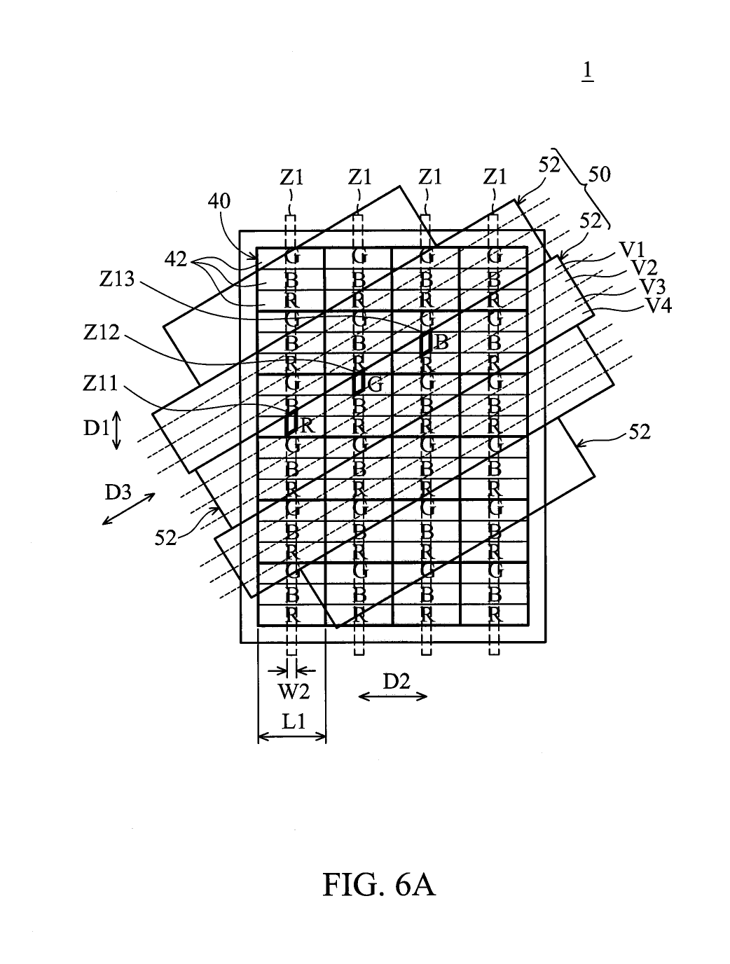

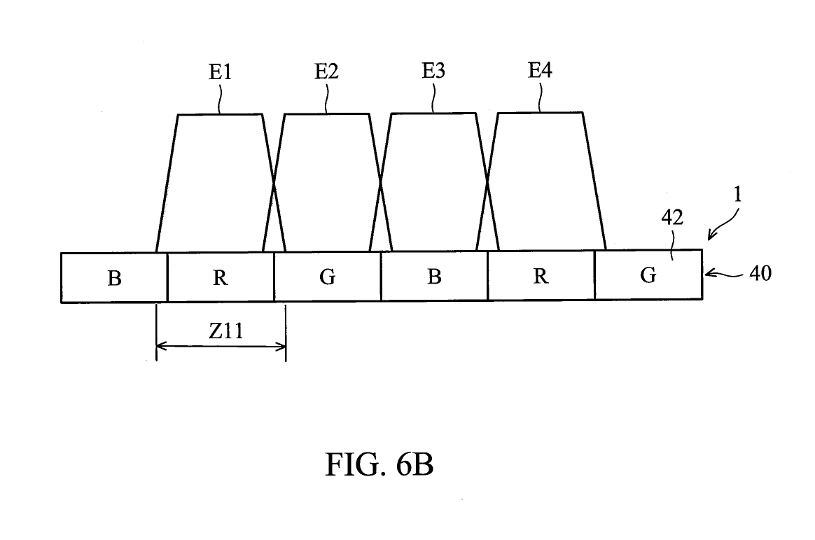

The illumination areas Z1 extend along the first direction D1, and are parallel to each other. The illumination areas Z1 pass through the center areas of the pixels 42 arranged in the first direction D1. The width W1 of the illumination areas Z1 is shorter than the length L1 of the pixels 42. The width of the illumination areas is a fraction of the length of the pixels. As shown in FIG. 3A, the length L1 of the pixels 42 is about 2 times of the width W1 of the illumination areas Z1. As shown in FIG. 6A, the length L1 of the pixels 42 is about 4 times the width W2 of the illumination areas Z1. The width W1 and the length L1 are measured in the second direction D2.

Therefore, the illumination of the pixels 42 in the illumination areas Z1 is greater than the illumination of the pixels 42 outside the illumination areas Z1. In some embodiments, the illumination of the pixels 42 in the illumination areas Z1 is greater than 1.5 times, 2 times or 3 times the illumination of the pixels 42 outside the illumination areas Z1. In some embodiments, the illumination of the pixels 42 in the illumination areas Z1 is 1.5 times to 50 times the illumination of the pixels 42 outside the illumination areas Z1. In some embodiments, the pixels 42 emit light beams in the illumination areas Z1, and do not emit light beam outside the illumination areas Z1.

As shown in FIG. 3A, an acute angle between the first direction D1 and the inclined direction D3 is tan⁻¹(3/2) degrees (about 56.3 degrees). Therefore, the second cylinder lens 52 is inclined relative to the extension direction of the pixels 42, and is inclined relative to the illumination areas Z1.

The pixels 42 include red pixels 42, green pixels 42, and blue pixels 42. In FIG. 3A, the labels “R” present the red pixels 42, the labels “G” present green pixels 42, and the labels “B” present blue pixels 42. The pixels 42 with different colors are alternately arranged in the first direction D1 (or third direction D3). Moreover, the pixels 42 with the same color are arranged in the second direction D2. In other words, when the display panel 40 is operated in portrait view as shown in FIG. 3A, the pixels 42 have the same color in a transverse direction.

In some embodiments, the pixels 42 include four or at least four colors, such as red, green, blue and yellow. In another embodiment, the pixels 42 include white pixels 42.

In this embodiment, when the user watches the stereoscopic display 1 from a first angle of view E1, a first image corresponding to the first angle of view E1 is presented to the user. When the user watches the stereoscopic display 1 from a second angle of view E2, a second image corresponding to the second angle of view E2 is presented to the user. When the user watches the stereoscopic display 1 from a third angle of view E3, a third image corresponding to the third angle of view E3 is presented to the user. When the user watches the stereoscopic display 1 from a fourth angle of view E4, a fourth image corresponding to the fourth angle of view E4 is presented to the user.

In this embodiment, each of the angles of view (the first angle of view E1, the second angle of view E2, the third angle of view E3, and the fourth angle of view E4) is defined as an angle between a connection line between the user' eye and a normal line (or a vertical line) of the center of the stereoscopic display 1 (the reference plane P1 or the light-emitting surface 421). For example, the first angle of view E1 is −2.7 degrees, the second angle of view E2 is −0.9 degrees, the third angle of view E3 is 0.9, and the fourth angle of view E4 is 2.7 degrees. The first images, the second images, and the third images are presented by the different arrays formed with different colors of the pixels 42, such as red, green and blue.

As shown in FIG. 3A and FIG. 3B, in this embodiment, the first angle of view E1 corresponds to the first image formed by the light beams emitted from the first segment V1 of the second cylinder lens 52. The second angle of view E2 corresponds to the second image formed by the light beams emitted from the second segment V2 of the second cylinder lens 52. The third angle of view E3 corresponds to the third image formed by the light beams emitted from the third segment V3 of the second cylinder lens 52. The fourth angle of view E4 corresponds to the fourth image formed by the light beams emitted from the fourth segment V4 of the second cylinder lens 52. The first segment V1, the second segment V2, the third segment V3 and the fourth segment V4 extend along the inclined direction D3.

As shown in FIG. 3A and FIG. 3B, the length L1 of the pixels 42 is about 2 times the width W1 of the illumination areas Z1. In the area Z11 of the first segment V1 corresponding to the first angle of view E1, the illumination area of the pixel 42 at the center of the area Z11 is greater than the illumination area of others pixels 42 in the area Z11. In this embodiment, in the area Z11, the illumination area of the pixel 42 at the center of the area Z11 is 4 times the illumination area of others pixels 42 in the area Z11. Therefore, the quantity of light seen by the user in the area Z11 corresponding to the first angle of view E1 is greater than the quantity of light corresponding to other angles of view.

Similarly, in the area Z12 (or the area Z13) in the first segment V1 corresponding to the first angle of view E1, the area of the green pixel 42 (or the blue pixel 42) corresponding to the first angle of view E1 is greater than the areas of other pixels 42 in the area Z12 (or the area Z13) corresponding to the first angle of view E1. In this embodiment, in the area Z12 (or the area Z13), the illumination area of the pixel 42 at the center of the area Z12 (or the area Z13) is 4 times the illumination area of others pixels 42 the area Z12 (or the area Z13). Therefore, the light beams of the image corresponding to the first angle of view are less interfered with other light beams of images corresponding to other angles of view. In this embodiment, the crosstalk of the image corresponding to one of the angles of view is about 25%.

In some embodiments, if the stereoscopic display 1 does not include the first lenticular structure 30, the width W1 of the illumination areas Z1 is equal to the length L1 of the pixels 42. In other words, each of the pixels 42 located at the light-emitting surface 211 emits uniformly or substantially uniformly light beams. Moreover, the pixel 42 in the area Z21 of the first segment V1 corresponding to the first angle of view E1 (as shown in FIG. 3A) emits uniformly light beam, and the area Z21 is greater than the area Z11.

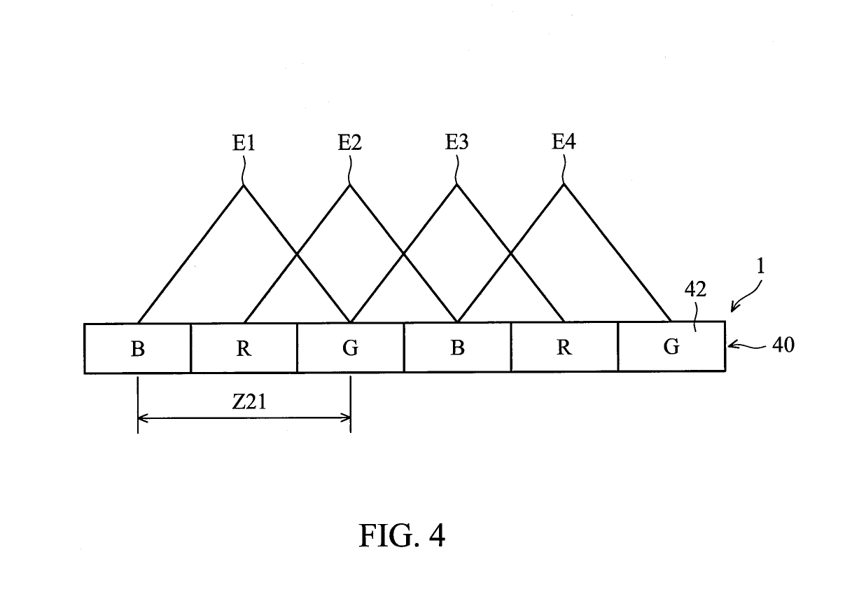

FIG. 4 is a schematic view of angles of view of the stereoscopic display 1 in accordance with some embodiments of the disclosure. Accordingly, if the stereoscopic display 1 does not includes the first lenticular structure 30, for example, in the area Z21 corresponding to first angle of view E1, the area emitting red light by the red pixel 42 is equal to the areas emitting other colors of light by other pixels 42. Therefore, if the stereoscopic display 1 does not include the first lenticular structure 30, the image corresponding to the first angles of view E1 is greatly interfered with the light beams of images corresponding to other angles of view. In this embodiment, the crosstalk of the image corresponding to one of the angles of view is about 100%.

Similarly, if the stereoscopic display 1 does not include the first lenticular structure 30, the red light (green light or blue light) of the first image, the second image, the third image, or the fourth image are greatly interfered with the light beams of other colors. Therefore, in the embodiment of the stereoscopic display 1 including the first lenticular structure 30, the first image, the second image, the third image and/or the fourth image includes more purely red light, green light, and blue light. Accordingly, the quality of the first image, the second image, the third image and/or the fourth image is improved. Moreover, the quality of the stereoscopic image is great, even when the user watches the stereoscopic display 1 via the first angle of view E1, the second angle of view E2, the third angle of view E3, or the fourth angle of view E4.

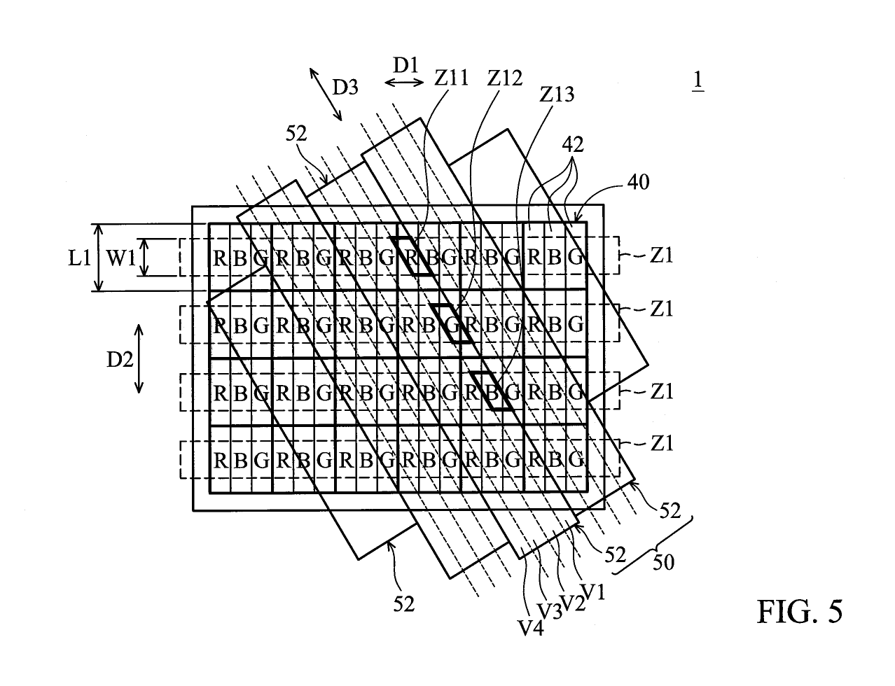

FIG. 5 is a schematic top view of the stereoscopic display 1 in another orientation in accordance with some embodiments of the disclosure. The stereoscopic display 1 is usually operated in landscape view. In some cases, when the stereoscopic display 1 is used for instruments or advertisements, the stereoscopic display 1 is usually operated in portrait view. In some embodiments, handheld devices with stereoscopic display 1 are often operated in landscape view or portrait view. Therefore, in this embodiment, the stereoscopic display 1 can present stereoscopic images in portrait view as shown in FIG. 3A, or present stereoscopic images in the landscape view as shown in FIG. 5.

FIG. 6A is a schematic top view of the stereoscopic display 1 in accordance with some embodiments of the disclosure. FIG. 6B is a schematic view of angles of view of the stereoscopic display 1 in accordance with some embodiments of the disclosure. In FIG. 6A, the length L1 of the pixels 42 is about 4 times the width W2 of the illumination areas Z1.

As shown in FIGS. 6A and 6B, in the area Z11 of the first segment V1 corresponds to the first angle of view E1, the area of the red pixel 42 is 8 times the areas of the pixels 42 with other colors. Therefore, the red light of the first image is less interfered with other colors of light beams. In this embodiment, the crosstalk of the image corresponds to one of the angles of view E1 is about 12.5%.

For example, as shown in FIG. 6B, the area of the red pixel 42 in the area Z11 corresponding to the first angle of view E1 is greater than the areas of the blue pixel 42 plus the green pixel 42 corresponding to the first angle of view E1. Moreover, the ratio of the areas of the red pixel 42 to the pixels 42 with other colors in FIG. 6B is greater than the areas of the red pixel 42 to the pixels 42 with other colors in FIG. 3B.

In the area Z12, the area of the green pixel 42 is greater than 8 times of the pixels 42 with other colors. Therefore, the green light of the first image is less interfered with the light beams with other colors. In the area Z13, the area of the blue pixel 42 is greater than 8 times of the pixels 42 with other colors. Therefore, in the embodiment of FIG. 6A and FIG. 6B, the blue light of the first image is less interfered by the light beam with other colors. Similarly, the red light (green light or blue light) of the second image, the third image, and the fourth image are less interfered with the light beams with other colors.

In conclusion, the stereoscopic display of the disclosure utilizes the first lenticular structure to provide stereoscopic images in different orientations. Moreover, by the second lenticular structure, the stereoscopic display can provide great quality of stereoscopic images in different orientations or when the stereoscopic display is viewed at different angles of view.

While the invention has been described by way of example and in terms of preferred embodiment, it is to be understood that the invention is not limited thereto. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A stereoscopic display, comprising:
a first lenticular structure comprising a plurality of first cylinder lenses extending along a first direction and parallel to each other;
a display panel disposed on the first lenticular structure; and
a second lenticular structure disposed on the display panel and comprising a plurality of second cylinder lenses extending along an inclined direction and parallel to each other;
wherein an acute angle is between the inclined direction and the first direction.

2. The stereoscopic display as claimed in claim 1, wherein the display panel comprises a plurality of pixels extending along a second direction and parallel to each other, and the second direction is perpendicular to the first direction.

3. The stereoscopic display as claimed in claim 2, wherein light beams passing through the first cylinder lenses are emitted from a plurality of illumination areas on a light-emitting surface of the display panel, and the illumination areas extend along the first direction and parallel to each other, wherein a width of the illumination areas is shorter than a length of the pixels, and the width and the length are measured in the second direction.

4. The stereoscopic display as claimed in claim 3, wherein the illumination areas pass through center areas of the pixels arranged in the first direction.

5. The stereoscopic display as claimed in claim 3, wherein the width of the illumination areas is a fraction of the length of the pixels.

6. The stereoscopic display as claimed in claim 3, wherein when the pixels emit light beams, an illumination in the illumination areas of the pixels is greater than an illumination outside the illumination areas of the pixels.

7. The stereoscopic display as claimed in claim 3, wherein the pixels are arranged on the light-emitting surface of the display panel in an array.

8. The stereoscopic display as claimed in claim 3, wherein the pixels comprise a plurality of green pixels, a plurality of blue pixels, and a plurality of red pixels, and the green pixels, the blue pixels, and the red pixels are alternately arranged in the first direction.

9. The stereoscopic display as claimed in claim 8, wherein some of the pixels with the same colors are arranged in the second direction.

10. The stereoscopic display as claimed in claim 1, wherein the first lenticular structure, the display panel, and the second lenticular structure are parallel to each other, the first cylinder lenses are located on a first plane, and the second cylinder lenses are located a second plane parallel to the first plane.

11. The stereoscopic display as claimed in claim 1, wherein the acute angle is in a range from 30 degrees to 60 degrees.

12. The stereoscopic display as claimed in claim 1, further comprising:
a light-guide plate disposed under the first lenticular structure; and
a light source disposed on a side of the light-guide plate.

13. The stereoscopic display as claimed in claim 12, wherein the light-guide plate further comprises a light-guide layer and a plurality of semi-cylindrical microlenses located at a bottom of the light-guide layer, wherein a diameter of the semi-cylindrical microlenses increases gradually from a side of the light-guide layer adjacent to the light source to another side that is far from the light source.

14. The stereoscopic display as claimed in claim 13, wherein the light source further comprises a condensing-lenticular structure and a plurality of light-emitting elements disposed on the condensing-lenticular structure.

15. The stereoscopic display as claimed in claim 14, wherein the condensing-lenticular structure comprises a plurality of condensing-cylinder lenses parallel to each other and adjacent to the light-guide plate.

16. A stereoscopic display, comprising:
a display panel;
a first lenticular structure disposed on the first lenticular structure, wherein the first lenticular structure comprises a plurality of first cylinder lenses extending along a first direction and parallel to each other; and
a second lenticular structure disposed on the display panel and comprising a plurality of second cylinder lenses extending along an inclined direction and parallel to each other;
wherein an acute angle is between the first direction and the inclined direction.
